(19) United States
(12) Patent Application Publication
(10) Pub. No.: US 2008/0251033 A1
(43) Pub. Date: Oct. 16, 2008

(54) ROPE TOY WITH EMBEDDED ATTRACTANT

(75) Inventor: Edward P. Dennis, Conifer, CO (US)

Correspondence Address: MARSH, FISCHMANN & BREYFOGLE LLP, 8055 East Tufts Avenue, Suite 450, Denver, CO, 80237, US

(73) Assignee: TOPET USA, INC., Morrison, CO (US)

(21) Appl. No.: 11/748,122

(22) Filed: May 14, 2007

Related U.S. Application Data
(60) Provisional application No. 60/912,087, filed on Apr. 16, 2007.

(51) Int. Cl. A01K 29/00

(52) U.S. Cl. 119/709

(57) ABSTRACT

A rope chew toy particularly adapted for domestic animals such as dogs. The rope chew toy includes rope strands that are braided around an attractant to form a braided rope segment having the attractant partially disposed within the braided rope segment. The attractant can be an animal by-product or similar treat that attracts and encourages the dog to chew upon the braided rope segment.

### CROSS REFERENCE TO RELATED APPLICATIONS

This application claims priority to U.S. Provisional Application No. 60/912,087 entitled ROPE TOY WITH EMBEDDED ATTRACTANT and filed Apr. 16, 2007, the disclosure of which is incorporated herein by reference in its entirety.

### BACKGROUND OF THE INVENTION

1. Field of the Invention

The present invention relates to pet toys for the amusement of domestic pets, such as dogs. In particular, the present invention relates to a rope chew toy that encourages the pet to chew on the rope, which can have the added benefit of cleaning the dog's teeth.

2. Description of Related Art

A known chew toy for dogs includes a length of rope made from cotton or a similar material such as polyester, and typically has knots formed near the ends of the rope, or at other positions along the length of the rope. The rope threads provide a cleaning and flossing effect for the dog's teeth and massage the dog's gums when chewed, and provides therapeutic dental benefits as well as amusement for the dog.

For example, U.S. Pat. No. 5,329,881 by O'Rourke discloses a rope chew toy for dogs that includes a length of cotton rope formed from a plurality of cotton threads that are impregnated with fluoride particles. When chewed, the fluoride combines with saliva on the teeth of the dog to prevent tooth decay. Fluoride particles are applied to the individual cotton fibers prior to forming the fibers into the length of rope.

U.S. Pat. No. 6,050,224 by Owens discloses a rope chew toy that includes a chewable rawhide disk attached to the length of rope between the two knots at end of the rope. The rawhide chew includes activated charcoal to absorb odor and bacteria from the dog when chewed upon by the dog.

One issue that is well-known to many dog owners is that dogs may quickly become bored with rope chew toys, and often will stop using the rope chew toy after a short period of time.

### SUMMARY OF THE INVENTION

It is an objective of the present invention to provide a rope chew toy that will encourage a dog to continue chewing on the rope.

Accordingly, the present invention provides a rope chew toy having an attractant embedded at least partially within the rope chew toy to encourage the dog to chew on the rope. The dog, in trying to reach the attractant, is thereby encouraged to continue chewing on the rope for an extended period of time, providing a significant dental health benefit.

According to one aspect, the embedded attractant is an elongate piece of an edible material, such as a rawhide, that is placed within a braided rope segment. Edible materials such as animal by-products, which can be smelled by the dog, can be completely embedded within the braided rope segment or can be partially exposed, such as by loosely braiding the rope about the attractant to provide gaps between adjacent rope strands.

According to another aspect, a method for the manufacture of a rope chew toy is provided. The method can include the steps of providing an elongate attractant material that is adapted to attract a dog. At least first and second rope strands are braided around the attractant to form a braided rope segment with the attractant embedded within the braided rope segment. The ends of the rope strands can then be fixed to secure the rope strands around the attractant. For example, the ends of the rope can be tied into knots.

These and other aspects and embodiments of the present invention will become apparent in accordance with the following description.

### DESCRIPTION OF THE DRAWINGS

FIG. 1 illustrates a perspective view of a rope chew toy according to an embodiment of the present invention.

FIG. 2 illustrates a cross-sectional view of a rope chew toy according to an embodiment of the present invention.

FIG. 3 illustrates a perspective view of a rope chew toy according to an embodiment of the present invention.

FIG. 4 illustrates a perspective view of a rope chew toy according to an embodiment of the present invention.

### DESCRIPTION OF THE INVENTION

Accordingly, the present invention provides a rope chew toy having an attractant embedded at least partially within the rope chew toy.

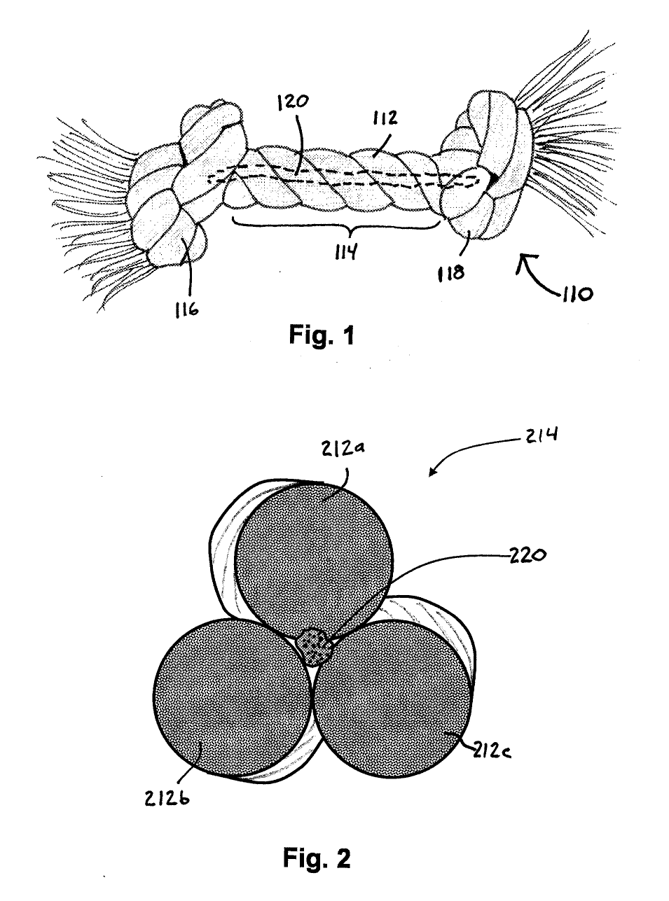

FIG. 1 illustrates a rope chew toy 110 according to an embodiment of the present invention. The rope chew toy 110 includes one or more individual rope strands 112 that are braided (e.g., twisted) along at least a portion of their length to form a braided rope segment 114. The chew toy can include a single rope strand, two rope strands, three rope strands, four rope strands or more. As illustrated in FIG. 1, the rope strands 112 are tied into knots 116 and 118 at distal ends of the rope strands 112. The rope strands 112 can be comprised of threads of, for example, cotton, polyester or a blend of cotton and polyester, or similar materials.

According to the present invention, an attractant 120 is embedded within the rope chew toy 110 to encourage the dog to chew upon the rope chew toy 110. Preferably, the attractant 120 is at least partially disposed within the braided rope segment 114. As is illustrated in FIG. 1, the attractant 120 can be disposed within the braided rope segment 114, such as by twisting the rope strands 112 around the attractant 120.

The attractant 120 can be any material that will attract a domestic animal, particularly a dog. The dog will thereby chew upon the rope chew toy 110 in an attempt to get to the attractant 120. In one embodiment, the attractant 120 is an edible animal by-product that has a scent that is attractive to the dog. One example is a rawhide. Rawhide is made from animal hide, typically cow hide, which has been cleaned, dried and cut into pieces. Flavors can be added to a rawhide to increase the attraction of the rawhide to the dog. The manufacture of rawhide is discussed in more detail in U.S. Pat. No. 6,935,275 by Jia et al., which is incorporated herein by reference in its entirety. Other animal by-products such as a beef stick that also produces an attractive scent for the dog can be used. Further, other edible food items such as meat jerky, or dry treats such as dog bones, dog cookies or the like can also be used as an attractant.

The attractant 120 is preferably an elongate piece of material that extends along at least a portion of the braided rope segment 114. More than one attractant can be embedded within the braided rope segment 114.

FIG. 2 illustrates a cross section of a braided rope segment 214 that is similar to the braided rope segment illustrated in FIG. 1. Three rope strands 212a, 212b and 212c are disposed around an attractant 220 to substantially embed the attractant 220 within the rope strands. In this manner, the dog will smell the attractant 220, but will be required to chew through the rope strands to reach the attractant 220. The attractant 220 can optionally have a substantially circular cross-section to facilitate twisting of the rope strands 212 around the attractant 220.

As illustrated in FIGS. 1 and 2, the attractant is embedded within the chew rope toy in a manner that the dog cannot see the attractant without chewing in the braided rope segment to begin to expose the attractant. Alternatively, the attractant may be partially exposed so that the dog can see and better smell the attractant.

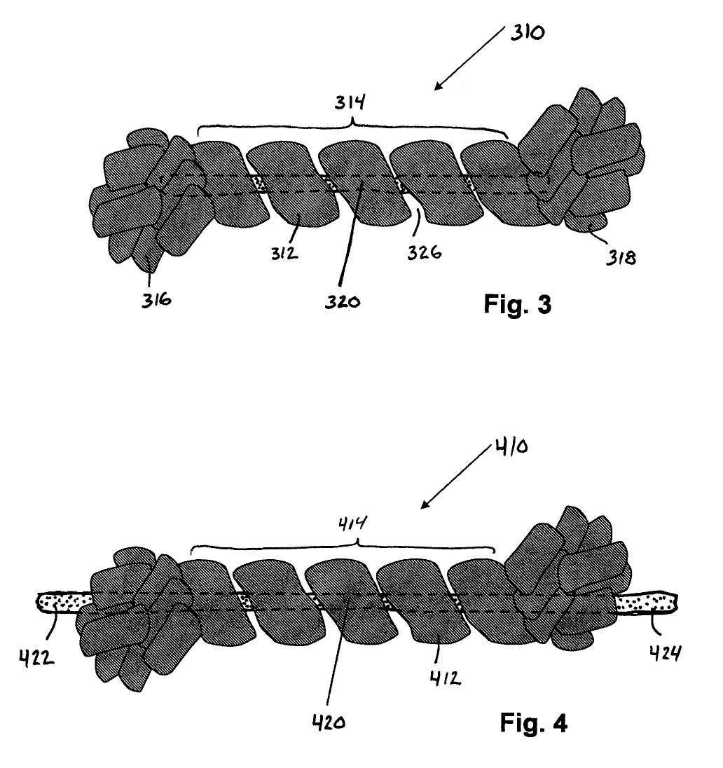

For example, FIG. 3 illustrates an embodiment of a rope chew toy 310 that includes rope strands 312 braided around an attractant 320. The rope strands 312 along the braided rope segment 314 are loosely braided, such that small gaps 326 exist between adjacent rope strands 312 along the length of the braided rope segment 314. In this way, portions of the attractant 320 are visibly exposed and also can be more easily smelled by the dog.

In the embodiment illustrated in FIG. 4, a rope chew toy 410 includes an attractant 420 disposed within the braided rope segment 414. Distal ends 422 and 424 of the attractant 420 extend beyond the length of the braided rope segment 414 and beyond the length of the rope chew rope toy 410.

Although illustrated herein as a single braided rope segment with a knot disposed at each end, other configurations of a rope chew toy can be utilized. For example, the rope toy could include more than two knots, or no knots, or can include a looped portion that can be held by a human to play with the dog. Some such configurations are disclosed in U.S. Pat. No. 4,924,811 by Axelrod, which is incorporated herein by reference in its entirety. Further, the ends of the rope strands can be affixed by means other than knots. For example, U.S. Pat. No. 5,174,243 by O'Rourke, which is incorporated herein by reference in its entirety, discloses a rope chew toy having plastic end members to affix the ends of rope strands in a rope chew toy.

The present invention also provides a method for the manufacture of a rope chew toy. The method can include the steps of providing an attractant material that is adapted to attract a dog, braiding at least first and second rope strands around the attractant to form a braided rope segment with the attractant embedded within the braided rope segment, and fixing the ends of the rope strands, such as by tying the rope strands into knots at each distal end of the strands.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A rope chew toy for dogs, comprising at least a first rope strand that is braided around an attractant to form a braided rope segment having an attractant at least partially disposed therein.

2. A rope chew toy as recited in claim 1, wherein said attractant comprises an animal by-product.

3. A rope chew toy as recited in claim 1, wherein said attractant comprises a rawhide.

4. A rope chew toy as recited in claim 1, wherein said rope strand comprises cotton threads.

5. A rope chew toy as recited in claim 1, wherein said rope strand comprises polyester threads.

6. A rope chew toy as recited in claim 1, wherein said rope chew toy comprises at least a second rope strand braided around said attractant.

7. A rope chew toy as recited in claim 1, wherein said rope chew toy comprises at least a third rope strand braided around said attractant.

8. A rope chew toy as recited in claim 1, wherein said rope strand is loosely braided around said attractant to provide gaps between adjacent portions of said rope strand.

9. A rope chew toy as recited in claim 1, wherein said rope strand is formed into a knot at a distal end of said rope chew toy.

10. A rope chew toy as recited in claim 1, wherein said attractant is disposed along the length of said braided rope segment.

11. A rope chew toy as recited in claim 1, wherein said attractant has a substantially circular cross-section.

12. A rope chew toy, comprising:
(a) a plurality of rope strands that are braided along at least a portion of their length to form a braided rope segment and that are tied into knots at distal ends of the rope strands; and
(b) an attractant disposed within said braided rope segment, the attractant comprising an animal by-product.

13. A rope chew toy as recited in claim 12, wherein said attractant comprises a rawhide.

14. A method for manufacturing a rope chew toy, comprising the steps of:
providing an elongate attractant material that is adapted to attract a dog;
braiding at least first and second rope strands around said attractant to form a braided rope segment with the attractant disposed within the braided rope segment; and
fixing the ends of the rope strands.

15. A method as recited in claim 14, wherein said attractant comprises an animal by-product.

16. A method as recited in claim 14, wherein said fixing step comprises tying said rope strands into a knot.
